(19) United States
(12) Patent Application Publication
(10) Pub. No.: US 2013/0181959 A1
(43) Pub. Date: Jul. 18, 2013

(54) SIGNAL OUTPUT APPARATUS AND SIGNAL TRANSMITTING AND RECEIVING SYSTEM

(71) Applicant: BUFFALO INC., Nagoya-shi (JP)

(72) Inventor: Tomoaki KOUYAMA, Nagoya-shi (JP)

(73) Assignee: BUFFALO INC., Nagoya-shi (JP)

(21) Appl. No.: 13/716,822

(22) Filed: Dec. 17, 2012

(30) Foreign Application Priority Data
Jan. 17, 2012 (JP) P2012-007542

(51) Int. Cl. G09G 5/10

(52) U.S. Cl. CPC G09G 5/10
USPC 345/207; 345/691

(57) ABSTRACT

A signal output apparatus including a light-emitting element, first brightness control circuitry and second brightness control circuitry. The first brightness control circuitry is supplied with a first signal and controls a brightness of the light-emitting element according to the first signal so as to illuminate the light-emitting element at a first brightness when the first signal is ON. The second brightness control circuitry is supplied with a second signal including at least first and second states and controls the light-emitting element to be illuminated at a second brightness different from the first brightness if the second signal assumes the first state when the light-emitting element is illuminated by the first control circuitry at the first brightness according to the first signal.

### CROSS REFERENCE TO RELATED APPLICATION

The present application claims priority to Japanese Patent Application No. 2012-007542 filed on Jan. 17, 2012, the disclosure of which is hereby incorporated by reference in its entirety.

### BACKGROUND

1. Field of the Disclosure

The present disclosure relates to a signal output apparatus and signal transmitting and receiving system adapted to output a signal using a light-emitting element.

2. Related Arts

Recent years have seen a variety of devices that are electrically controlled. In the event of an anomaly in such a device, debug information indicating the type of anomaly that has occurred is extracted from the device in question to diagnose the device using the debug information.

Incidentally, a connector is, for example, provided on the board of the device to extract debug information. However, providing a connector leads to an increased cost. Further, there is a risk of alteration of the device, for example, by an ill-willed user controlling the internal circuitry of the device via the connector. Another alternative to consider would be to output debug information as an optical signal using a light-emitting element. In this case, it is necessary to provide a dedicated light-emitting element adapted to output debug information, thus resulting in the same problems as when providing a connector.

Japanese Patent Laid-open No. 2007-206449 describes a technique that has achieved compatibility between information display and sensor capability by switching between two modes. These modes are a light-up mode adapted to light up a semiconductor light-emitting element and a sensor mode adapted to extinguish the light-emitting element and cause the same element to serve as a sensor quickly in a time-divided manner under the recognition that if a light-receiving element and light-emitting element are arranged parallel to each other to receive light, it has been difficult to allow an LED to serve as a sensor while at the same time displaying information on the LED.

### SUMMARY OF THE DISCLOSURE

As described above, a component adapted to output debug information has been separately provided in the devices in the past, thus leading to concerns about possible increased cost and tampering.

In light of the foregoing, it is desirable to provide a signal output apparatus and signal transmitting and receiving system that can keep the increase in cost to a minimum and output debug information without the user readily noticing the existence thereof.

According to an embodiment of the present disclosure, there is provided a signal output apparatus that includes a light-emitting element and first and second brightness control circuitry. The first brightness control circuitry is supplied with a first signal and controls the brightness of the light-emitting element according to the first signal, thus illuminating the light-emitting element at a first brightness when the first signal is ON. The second brightness control circuitry is supplied with a second signal including at least first and second states and controls the light-emitting element to be illuminated at a second brightness different from the first brightness if the second signal assumes the first state when the light-emitting element is illuminated by the first control circuitry at the first brightness according to the first signal.

Thus, if the first and second signals are displayed with a single light-emitting element, it is possible to output, for example, debug information together with other information via the light-emitting element, thus keeping the increase in cost to a minimum and outputting debug information without the user readily noticing the existence thereof.

The present disclosure allows two signals, i.e., first and second signals, to be displayed with a single light-emitting element, keeps the increase in cost to a minimum and allows debug information to be output without the user readily noticing the existence thereof.

### BRIEF DESCRIPTION OF THE DRAWINGS

FIG. 1 is a block diagram illustrating a configuration example of an information transmitting and receiving system according to an embodiment of the present disclosure;

FIG. 2 is a circuit diagram illustrating an example of a light emission control circuit according to an example of a signal output apparatus according to the embodiment of the present disclosure;

FIG. 3 is an explanatory diagram illustrating the operation of the light emission control circuit according to an example of the signal output apparatus according to the embodiment of the present disclosure;

FIGS. 4A and 4B are circuit diagrams illustrating an example of the light emission control circuit according to another example of the signal output apparatus according to the embodiment of the present disclosure;

FIG. 5 is an explanatory diagram illustrating the operation of the light emission control circuit according to another example of the signal output apparatus according to the embodiment of the present disclosure;

FIG. 6 is a circuit diagram illustrating an example of the light emission control circuit according to still another example of the signal output apparatus according to the embodiment of the present disclosure;

FIG. 7 is an explanatory diagram illustrating the operation of the light emission control circuit according to still another example of the signal output apparatus according to the embodiment of the present disclosure;

FIGS. 8A to 8D are explanatory diagrams illustrating examples of an optical signal output by the signal output apparatus according to the embodiment of the present disclosure;

FIG. 9 is a circuit diagram illustrating an example of the light emission control circuit according to still another example of the signal output apparatus according to the embodiment of the present disclosure; and

FIG. 10 is an explanatory diagram illustrating the operation of the light emission control circuit according to still another example of the signal output apparatus according to the embodiment of the present disclosure.

### DESCRIPTION OF THE DISCLOSURE

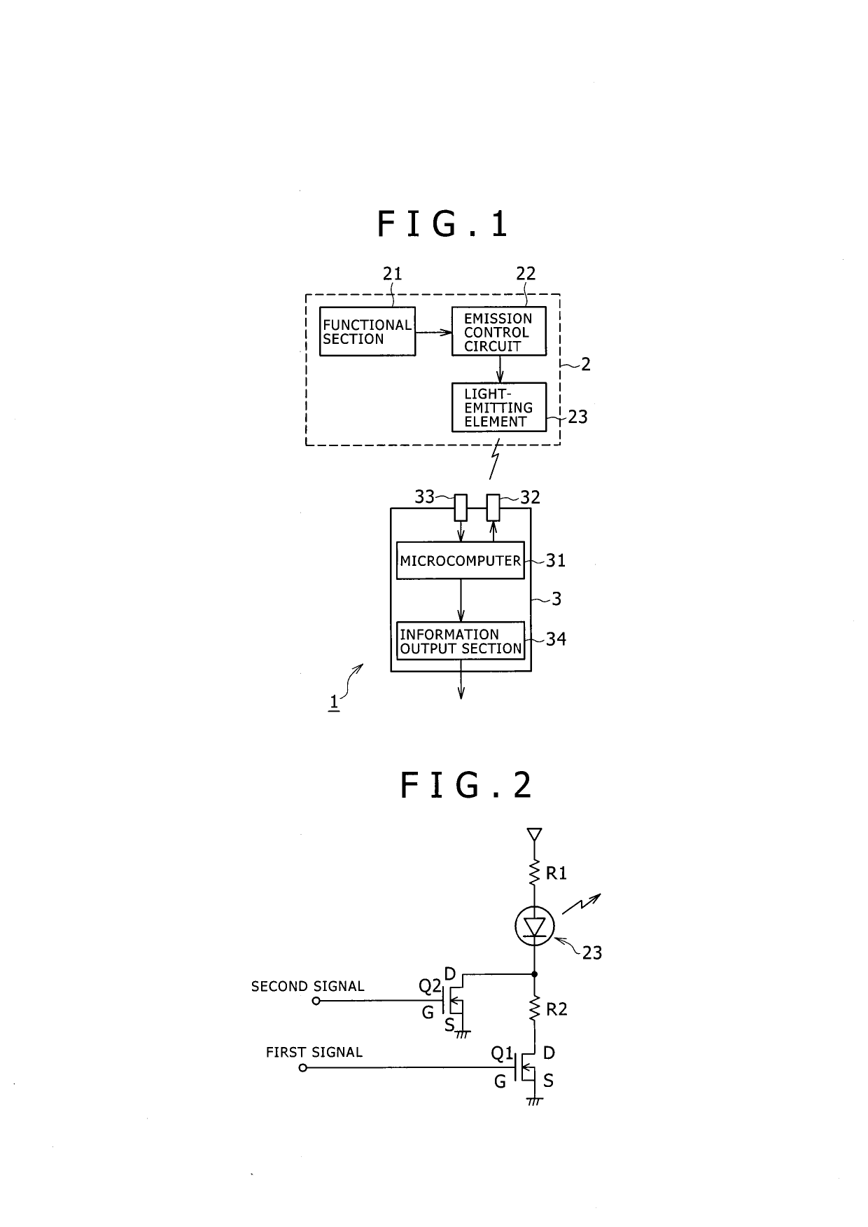

A description will be given below of the embodiment of the present disclosure with reference to the accompanying drawings. An information transmitting and receiving system 1 according to the embodiment of the present disclosure (present embodiment) includes a signal output apparatus 2 and signal reception apparatus 3 as illustrated in FIG. 1. Here, the signal output apparatus 2 is a hard disk apparatus, video device connected to a home television set, audio device, mobile terminal device or one of various other devices and includes a functional section 21, emission control circuit 22 and light-emitting element 23. The functional section 21 provides functionality specific to each device. The signal reception apparatus 3 includes a microcomputer 31, light-emitting element 32, light-receiving element 33 and information output section 34.

The functional section 21 of the signal output apparatus 2 provides functionality for the device to serve as such. In the case of a hard disk apparatus, the functional section 21 writes specified data to the hard disk in response to an instruction from external equipment to do so or reads specified data from the hard disk apparatus in response to an instruction from external equipment to do so. Further, the functional section 21 outputs a plurality of signals to the emission control circuit 22 via the light-emitting element 23.

Here, we assume that each of the plurality of signals is a multi-value signal including at least first and second states such as “low” and “high.” An example thereof may be a signal representing the current passage condition (ON/OFF state of the power). Other examples thereof are a signal indicating debug information, a signal which is ON when the hard disk is accessed, and a signal relating to ON/OFF of one of the segments of a multi-segment LED (Light Emission Diode) indicating the channel being tuned. In each of these signals, the “low” and “high” potentials from the common terminal (GND) need not always be the same. For example, the potential difference between the “low” and “high” states of the signal representing the current passage condition may be 3.3 V, and that between the “low” and “high” states of the signal representing debug information may be 1.8 V.

In one form of the present embodiment, the functional section 21 continues to output one of the signals (first signal) including that representing the current passage condition while the power is ON. Then, the same section 21 outputs a signal (second signal) different from the first signal as a signal to be superimposed on the first signal when instructed to do so by the user or when a predetermined time comes.

The emission control circuit 22 treats one of the plurality of signals supplied from the functional section 21 as a first signal and the other as a second signal and controls the ON/OFF state of the light-emitting element 23 according to the first signal. More specifically, the emission control circuit 22 operates as a first brightness control block adapted to light up the light-emitting element 23 at a first brightness when the first signal is ON.

Further, the emission control circuit 22 controls the brightness of the light-emitting element 23 according to the second signal when the functional section 21 outputs the second signal. For example, the same section 22 also operates as a second brightness control block adapted to control the brightness of the light-emitting element 23 in such a manner as to light up the same element 23 at a second brightness (may be unlit which is “0” brightness) different from the first brightness if the second signal assumes a predetermined first state (e.g., “high”) when the light-emitting element 23 is lit at the first brightness according to the first signal. It is to be noted that if the second signal is a multi-value signal, the light-emitting element 23 is controlled to light at the brightness of respective values. At this time, the side adapted to receive the second signal restores the second signal by investigating at which brightness the light-emitting element 23 is lit. A description will be given below assuming that the second signal is a binary signal for reasons of explanation.

The light-emitting element 23 is an LED (Light Emission Diode) or other light-emitting element whose brightness can be controlled according to the current flow therethrough.

A description will be given next of specific forms of the emission control circuit 22 and light-emitting element 23 with reference to FIG. 2. The emission control circuit 22 illustrated in FIG. 2 includes first and second transistors Q1 and Q2 and first and second resistors R1 and R2. Here, the first and second transistors Q1 and Q2 are both n-type FETs (field effect transistors). Here, the first resistor R1 has its one end connected to the power source potential. Further, the first resistor R1 has its other end connected to one end of the light-emitting element 23.

The light-emitting element 23 has its other end connected to the drain terminal (D) of the second transistor Q2. Further, the gate terminal (G) of this second transistor Q2 is supplied with the second signal. In the example shown here, we assume that both the first and second signals take on one of the electrically “high” and “low” states (one of the first and second states). As has been already described, the first and second signals need not have the same potentials when they are “low” and “high.” For example, the first signal may have a peak-to-peak change of 3.3 V, and the second signal 1.8 V. In the description given below, we assume that the potentials at both levels are the same.

Further, the light-emitting element 23 has its other end, i.e., the drain terminal (D) of the second transistor Q2, further connected to the drain terminal (D) of the first transistor Q1 via the second resistor R2. The gate terminal (G) of this first transistor Q1 is supplied with the first signal. Further, both of the first and second transistors Q1 and Q2 have their source terminals (S) connected to a common terminal (GND). The power source potential is maintained by the power source at a potential level which is a predetermined potential higher than the potential of this common terminal. Of these, the resistors R1 and R2 and first transistor Q1 correspond to the first brightness control block, and the second transistor Q2 the second brightness control block.

In the circuit illustrated in FIG. 2, when the first signal is ON (high) and the second signal is OFF (low), the first transistor Q1 conducts between the drain terminal (D) and source terminal (S), but not the second transistor Q2. In this condition, current i that has passed through the first resistor R1 and light-emitting element 23 reaches the common terminal (GND) via the second resistor R2. In other words, the current flow through the light-emitting element 23 is determined by the sum of an internal resistance r of the same element 23 (the same element 23 may be assumed to have a resistance connected in series thereto, and in this case, the sum of the internal resistance of the same element and the resistance connected in series is the internal resistance r) and the resistances of the first and second resistors R1 and R2.

On the other hand, when the first and second signals are both ON (high) (corresponds to the first state), both the first and second transistors Q1 and Q2 conduct between the drain terminal (D) and source terminal (S). In this case (assuming that the internal resistance of the second transistor Q2 is negligible as compared to the resistance of the second resistor R2), current flows through the first resistor R1 first, then the light-emitting element 23, then the drain and source of the second transistor Q2, and into the common terminal (GND). In other words, the current flow through the light-emitting element 23 is determined by the sum of the internal resistance r of the same element 23 and the resistance of the first resistor R1. This current flow is larger than that determined by the sum of the internal resistance r of the same element 23 and the resistances of the first and second resistors R1 and R2.

Here, the resistance of the second resistor R2 is not zero. Therefore, even when the first signal is ON, the current flow through the light-emitting element 23 changes as the second signal turns ON or OFF, thus changing the brightness thereof. Here, the brightness of the light-emitting element 23 when the first signal is ON and the second signal is OFF (low) corresponds to the first brightness, and the second brightness different from the first brightness corresponds to the brightness of the light-emitting element 23 when both the first and second signals are ON (high). Here, more current flows through the light-emitting element 23 at the second brightness than at the first brightness. As a result, the same element 23 is lit brighter at the second brightness.

Further, when the first and second signals are both OFF (low), neither the first transistor Q1 nor the second transistor Q2 conduct between the drain terminal (D) and source terminal (S). As a result, no current flows through the light-emitting element 23. In other words, the brightness of the same element 23 is “0.” In this example, this brightness (“0” brightness) corresponds to a third brightness.

Then, when the first signal is OFF (low), and the second signal is ON (high), the second transistor Q2 conducts between the drain terminal (D) and source terminal (S). Therefore (assuming that the internal resistance of the second transistor Q2 is negligible), current flows through the first resistor R1 first, then the light-emitting element 23, then the drain and source of the second transistor Q2, and into the common terminal (GND). In other words, the current flow through the light-emitting element 23 is determined by the sum of the internal resistance r of the same element 23 and the resistance of the first resistor R1. The brightness at this time is the second brightness, remaining unchanged from that when the first and second signals are both ON (high).

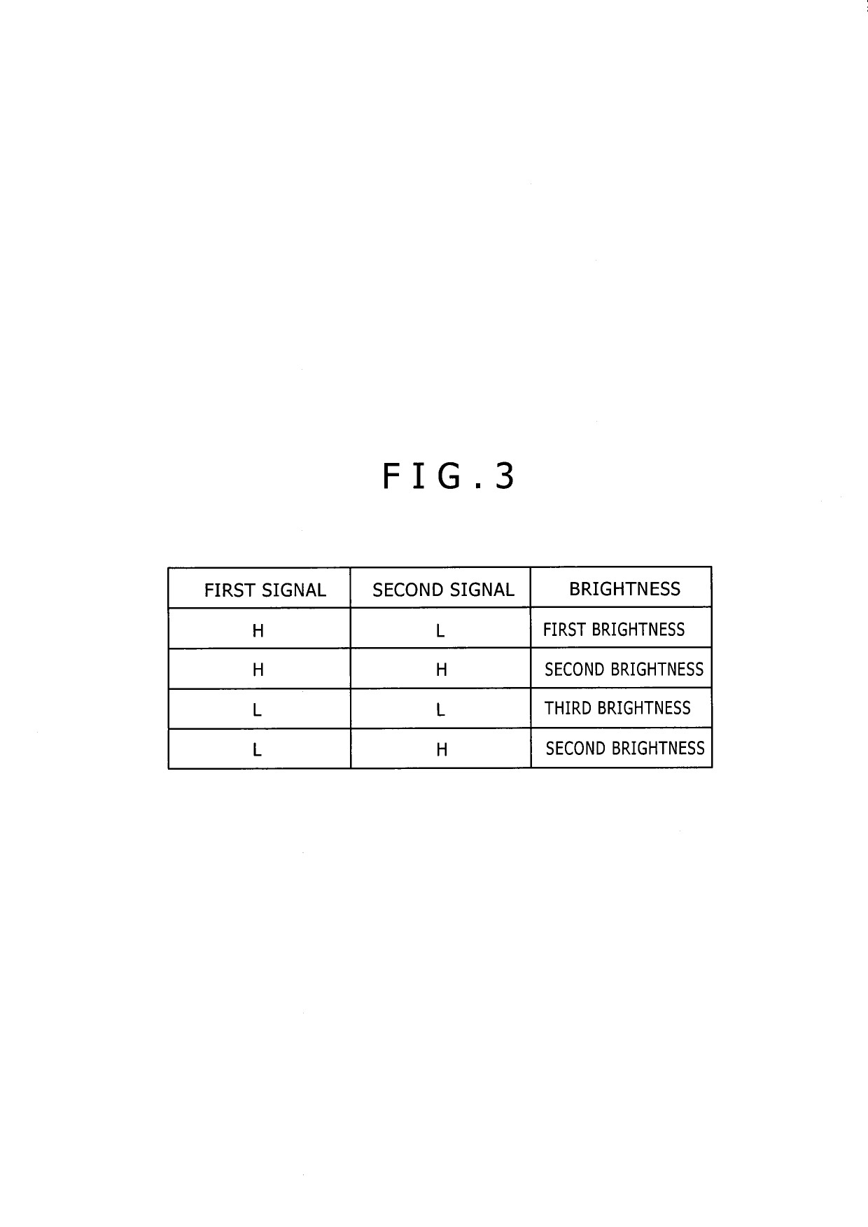

That is, in the circuit illustrated in FIG. 2, the emission brightness of the light-emitting element 23 changes according to the states of the first and second signals as illustrated in FIG. 3. In other words, when the second signal is “high,” the light-emitting element 23 emits light at the second brightness irrespective of whether the first signal is “high” or “low.” On the other hand, if the second signal is “low,” the light-emitting element 23 emits light at the first brightness when the first signal is “high” and at the “0” brightness (third brightness) when the first signal is “low.”

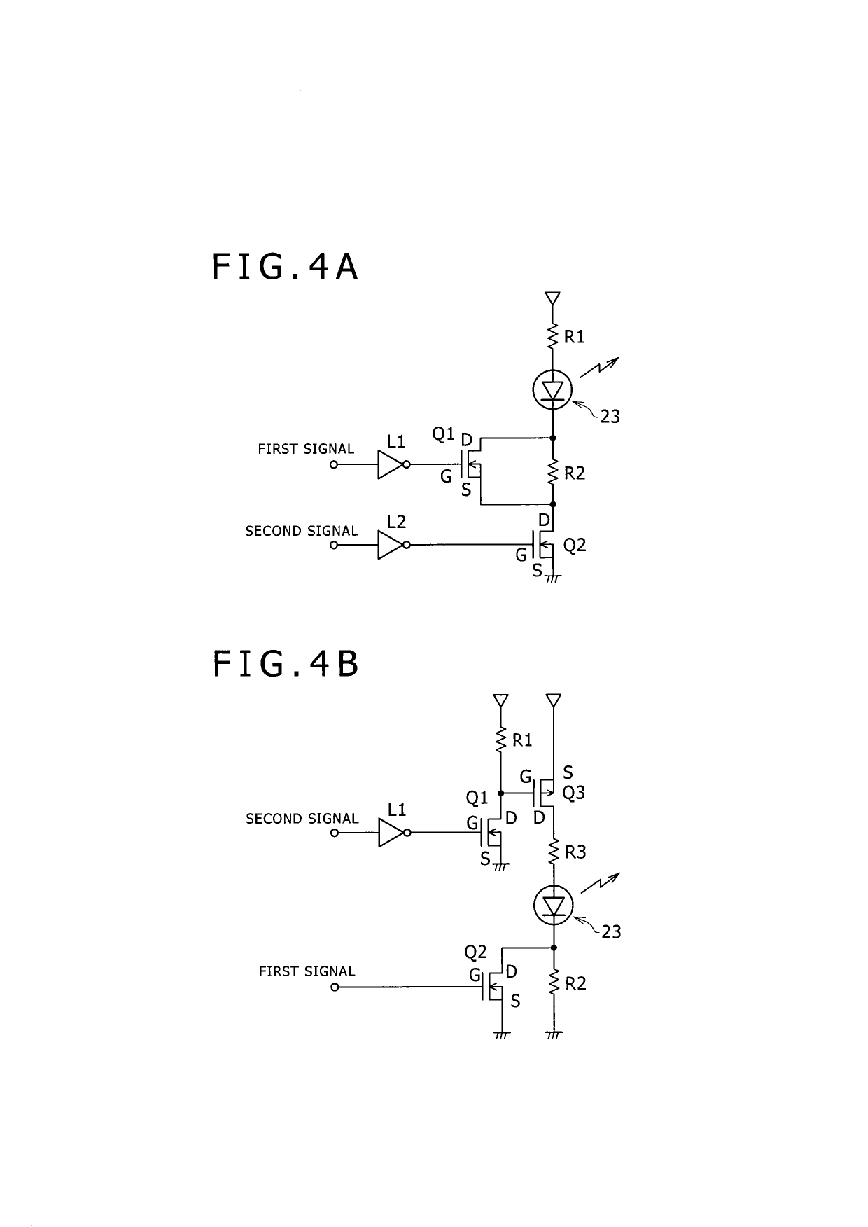

On the other hand, the specific forms of the emission control circuit 22 and light-emitting element 23 are not limited to the examples shown in FIG. 2. FIGS. 4A and 4B illustrate other examples of the emission control circuit 22 and light-emitting element 23 in the present embodiment. The emission control circuit 22 shown in FIG. 4A includes the first and second transistors Q1 and Q2, first and second resistors R1 and R2 and inverter circuits L1 and L2. Here, the first resistor R1 has its one end connected to the power source potential. Further, the first resistor R1 has its other end connected to one end of the light-emitting element 23.

The light-emitting element 23 has its other end connected to the drain terminal (D) of the first transistor Q1. Further, the gate terminal (G) of this first transistor Q1 is supplied with the first signal via the inverter circuit L1. In the example shown here, we also assume that both the first and second signals take on one of the electrically “high” and “low” states (one of the first and second states).

Further, the light-emitting element 23 has its other end, i.e., the drain terminal (D) of the first transistor Q1, further connected to the drain terminal (D) of the second transistor Q1 via the second resistor R2. The gate terminal (G) of this second transistor Q2 is supplied with the second signal via the inverter circuit L2. On the other hand, the first transistor Q1 has its source terminal (S) connected to the drain terminal (D) of the second transistor Q2, and the second transistor Q2 has its source terminal (S) connected to the common terminal (GND). The power source potential is maintained by the power source at a potential level which is a predetermined potential higher than the potential of this common terminal. Of these, the resistors R1 and R2 and first transistor Q1 correspond to the first brightness control block, and the second transistor Q2 the second brightness control block.

In the circuit illustrated in FIG. 4A, when the first signal is ON (high) and the second signal is OFF (low), the gate terminal (G) of the first transistor Q1 is supplied with an OFF signal via the inverter circuit L1. Therefore, the first transistor Q1 does not conduct between the drain terminal (D) and source terminal (S). On the other hand, the gate terminal (G) of the second transistor Q2 is supplied with an ON (high) signal via the inverter circuit L2. As a result, the second transistor Q2 conducts between the drain terminal (D) and source terminal (S). Therefore (assuming that the internal resistance of the second transistor Q2 is negligible), current flows through the first resistor R1 first, then the light-emitting element 23, then the second resistor R2, then the drain and source of the second transistor Q2, and into the common terminal (GND). In other words, the current flow through the light-emitting element 23 is determined by the sum of the internal resistance r of the same element 23 and the resistances of the first and second resistors R1 and R2.

On the other hand, when the first signal is ON (high) while the second signal is ON (high), the gates (G) of both of the first and second transistors Q1 and Q2 are OFF (low) because of the actions of the inverter circuits L1 and L2. As a result, neither the first transistor Q1 nor the second transistor Q2 conduct between the drain terminal (D) and source terminal (S). In other words, no current flows through the light-emitting element 23, and the brightness of the same element 23 is “0.” In this example, this brightness (“0” brightness) corresponds to a third brightness.

Further, when the first and second signals are both OFF (low), the gate terminals (G) of both the first and second transistors Q1 and Q2 are “high” because of the actions of the inverter circuits L1 and L2. As a result, both the first and second transistors Q1 and Q2 conduct between the drain terminal (D) and source terminal (S). In this case (assuming that the internal resistance of the first transistor Q1 is negligible as compared to the resistance of the second resistor R2), current flows through the first resistor R1 first, then the light-emitting element 23, then the drain terminal (D) and source terminal (S) of the first transistor Q1, then the drain terminal (D) and source terminal (S) of the second transistor Q2, and into the common terminal (GND). In other words, the current flow through the light-emitting element 23 is determined by the sum of the internal resistance r of the same element 23 and the resistance of the first resistor R1. This current flow is larger than that determined by the sum of the internal resistance r of the same element 23 and the resistances of the first and second resistors R1 and R2. Therefore, the brightness (second brightness) of the light-emitting element 23 at this time is higher than that (first brightness) when the first signal is ON (high) and the second signal is OFF (low) in FIG. 4A.

Further, when the second signal is ON (high) and the first signal is OFF (low), the gate terminal (G) of the first transistor Q1 is supplied with an ON (high) signal via the inverter circuit L1. Therefore, the first transistor Q1 conducts between the drain terminal (D) and source terminal (S). On the other hand, the gate terminal (G) of the second transistor Q2 is supplied with an OFF (low) signal via the inverter circuit L2. Therefore, the second transistor Q2 does not conduct between the drain terminal (D) and source terminal (S). For this reason, the current i that has passed through the first resistor R1 and then the light-emitting element 23 flows through the drain terminal (D) and source terminal (S) of the first transistor Q1 and into the drain terminal (D) of the second transistor Q2. However, the second transistor Q2 is OFF. Therefore, the current flow through the light-emitting element 23 is “0.” As a result, the brightness thereof is “0” (third brightness).

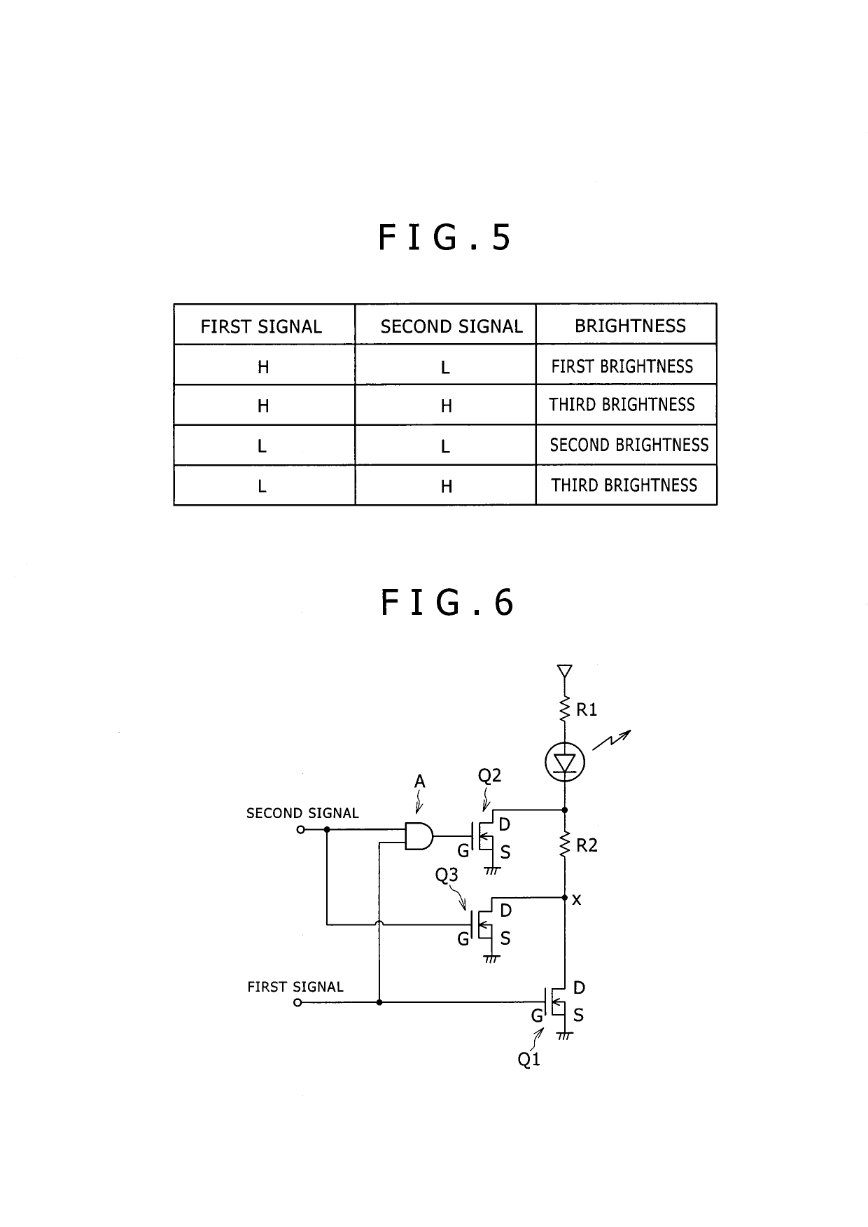

That is, in the circuit illustrated in FIG. 4A, the emission brightness of the light-emitting element 23 changes as illustrated in FIG. 5 according to the states of the first and second signals. In other words, when the first signal is “high” and the second signal “low,” the light-emitting element 23 emits light at the first brightness. When the first and second signals are both “high,” the light-emitting element 23 emits light at the third brightness. As already described, the “0” brightness is the third brightness.

On the other hand, when the first signal is “low” and the second signal “high,” the light-emitting element 23 emits light at the third brightness. When the first and second signals are both “low,” the light-emitting element 23 emits light at the second brightness.

It should be noted that although the gate terminal (G) of the first transistor Q1 is supplied with the first signal via the inverter L1, this inverter L1 is not typically necessary.

Alternatively, the emission control circuit 22 may be as illustrated in FIG. 4B. The emission control circuit 22 illustrated in FIG. 4B includes the first and second transistors Q1 and Q2, a third transistor Q3, first and second resistors R1 and R2, a third resistor R3, and the inverter circuit L1. The first and second transistors Q1 and Q2 are both n-type FETs (field effect transistors), and the third transistor Q3 a p-type FET.

In the circuit shown in FIG. 4B, the first resistor R1 has its one end connected to the power source potential. Further, this first resistor R1 has its other end connected to the drain terminal (D) of the first transistor Q1 and the gate terminal (G) of the third transistor Q3. It should be noted that the gate terminal (G) of the first transistor Q1 is supplied with the second signal via the inverter circuit L1.

The third transistor Q3 has its source terminal (S) connected to the power source potential. The same transistor Q3 has its drain terminal (D) connected to one end of the light-emitting element 23 via the third resistor R3. Further, the light-emitting element 23 has its other end connected to the drain terminal (D) of the second transistor Q2 and to the common terminal (GND) via the second resistor R2.

The gate terminal (G) of the second transistor Q2 is supplied with the first signal. Further, the same transistor Q2 has its source terminal (S) connected to the common terminal (GND).

In the example shown here, we also assume that both the first and second signals take on one of the electrically “high” and “low” states (one of the first and second states).

The power source potential is maintained by the power source at a potential level which is a predetermined potential higher than the potential of this common terminal. Of these, the resistor R2 and second transistor Q2 correspond to the first brightness control block, and the first and third transistors Q1 and Q3 the second brightness control block.

In the circuit illustrated in FIG. 4B, when the first signal is ON (high), the gate terminal (G) of the second transistor Q2 is supplied with an ON (high) signal. As a result, the second transistor Q2 conducts between the drain terminal (D) and source terminal (S).

As described above, when the first signal is ON (high) and the second signal is OFF (low), the gate terminal (G) of the first transistor Q1 is supplied with an ON (high) signal via the inverter circuit L1. As a result, the first transistor Q1 conducts between the drain terminal (D) and source terminal (S), thus connecting the potential of the gate terminal (G) of the third transistor Q3 to the common terminal (GND) and turning ON the third transistor Q3.

For this reason, current is supplied to the light-emitting element 23 via the third transistor Q3. Further, current passes through the light-emitting element 23 and second transistor Q2 and into the common terminal (GND). In other words, the current flow through the light-emitting element 23 is determined by the sum of the internal resistance r of the same element 23 and the resistance of the third resistor R3.

On the other hand, when the first and second signals are both ON (high), the gate terminal (G) of the first transistor Q1 is OFF (low) via the inverter circuit L1. As a result, the first transistor Q1 does not conduct between the drain terminal (D) and source terminal (S).

This brings the gate electrode (G) of the third transistor Q3 to a higher potential than the common terminal (GND), thus turning ON this gate electrode (G) (changing the same electrode to high level). As a result, the third transistor Q3 does not conduct between the drain terminal (D) and source terminal (S). For this reason, no current flows through the light-emitting element 23, and the brightness of the same element 23 is “0.” In this example, this brightness corresponds to the third brightness.

Further, when the first signal is OFF (low), the gate terminal (G) of the second transistor Q2 is supplied with an OFF (low) signal. As a result, the second transistor Q2 does not conduct between the drain terminal (D) and source terminal (S).

When the second signal is OFF (low) at this time, the gate terminal (G) of the first transistor Q1 is supplied with an ON (high) signal because of the action of the inverter circuit L1. As a result, the first transistor Q1 conducts between the drain terminal (D) and source terminal (S). In this case, the gate terminal (G) of the third transistor Q3 is connected to the common terminal (GND), thus turning ON the third transistor Q3.

For this reason, current is supplied to the light-emitting element 23 via the third transistor Q3 and third resistor R3. Further, current passes through the light-emitting element 23 and second transistor Q2 and into the common terminal (GND). In other words, the current flow through the light-emitting element 23 is determined by the sum of the resistance of the third resistor R3, the internal resistance r of the light-emitting element 23 and the resistance of the second resistor R2. This current flow is larger than that determined by the sum of the internal resistance r of the same element 23 and the resistance of the third resistor R3. Therefore, the brightness (second brightness) of the light-emitting element 23 is higher than that (first brightness) when the first signal is ON (high) and the second signal is OFF (low).

Further, when the first signal is OFF (low) and the second signal is ON (high), the gate terminal (G) of the first transistor Q1 is OFF (low) via the inverter circuit L1. For this reason, the first transistor Q1 does not conduct between the drain terminal (D) and source terminal (S).

This brings the gate electrode (G) of the third transistor Q3 to a higher potential than the common terminal (GND), thus turning ON this gate electrode (G) (changing the same electrode to high level). As a result, the third transistor Q3 does not conduct between the drain terminal (D) and source terminal (S). For this reason, no current flows through the light-emitting element 23, and the brightness of the same element 23 is “0” (third brightness).

That is, in the circuit illustrated in FIG. 4B, the emission brightness of the light-emitting element 23 changes according to the states of the first and second signals as illustrated in FIG. 5 in the same manner as in the example illustrated in FIG. 4A.

Further, FIG. 6 illustrates still other specific forms of the emission control circuit 22 and light-emitting element 23. In the example shown in FIG. 6, the emission control circuit 22 includes an AND circuit A, the first to third transistors Q1 to Q3 and first and second resistors R1 and R2. Here, the first resistor R1 has its one end connected to the power source potential. Further, the first resistor R1 has its other end connected to one end of the light-emitting element 23. In this example, the transistors Q1 to Q3 are all n-type FETs.

Further, the light-emitting element 23 has its other end connected to the drain terminal (D) of the second transistor Q2. On the other hand, the output of the AND circuit A adapted to be supplied with the first and second signals and output a signal corresponding to the logical product of the two signals is connected to the gate terminal (G) of the second transistor Q2. In the example shown here, we also assume that both the first and second signals take on one of the electrically “high” and “low” states (one of the first and second states), and that the AND circuit A produces a “high” output only if both signals are “high” and produces a “low” output in any other cases.

Further, the light-emitting element 23 has its other end, i.e., the drain terminal (D) of the second transistor Q2, further connected to the drain terminal (D) of the first transistor Q1 via the second resistor R2. The virtual terminal equipotential to the drain terminal (D) of the first transistor Q1 will be hereinafter referred to as the terminal X. The gate terminal (G) of the first transistor Q1 is supplied with the first signal. Further, the first transistor Q1 has its drain terminal (D) (terminal X) connected to the drain terminal (D) of the third transistor Q3. The gate terminal (G) of the third transistor Q3 is supplied with the second signal.

Still further, the first, second and third transistors Q1, Q2 and Q3 have their source terminals (S) connected to the common terminal (GND). The power source potential is maintained by the power source at a potential level which is a predetermined potential higher than the potential of this common terminal. Of these, the resistors R1 and R2 and first transistor Q1 correspond to the first brightness control block, and the second and third transistors Q2 and Q3 the second brightness control block.

In the circuit illustrated in FIG. 6, when the first signal is ON (high) and the second signal is OFF (low), the gate terminal (G) of the first transistor Q1 is supplied with a “high” signal. As s result, the same transistor Q1 conducts between the drain terminal (D) and source terminal (S). The output of the AND circuit A is “low,” and the gate terminal (G) of the second transistor Q2 is supplied with the second signal (at low level). As a result, neither the second transistor Q2 nor the third transistor Q3 conduct between the drain terminal (D) and source terminal (S).

Therefore, the first signal is ON (high) and the second signal is OFF (low), the current i that has passed through the first resistor R1 and then the light-emitting element 23 flows through the second resistor R2 and into the common terminal (GND). In other words, the current flow through the light-emitting element 23 is determined by the sum of the internal resistance r of the same element 23 and the resistances of the first and second resistors R1 and R2.

When the first and second signals are both ON (high) and the second signal is OFF (low), the output of the AND circuit A is “high.” At this time, the gate terminals (G) of the first, second, and third transistors Q1, Q2, and Q3 are “high.” Therefore, these transistors conduct between the drain terminal (D) and source terminal (S). In this case (assuming that the internal resistance of the second transistor Q2 is negligible), current flows through the first resistor R1 first, then the light-emitting element 23, then the drain and source of the second transistor Q2, and into the common terminal (GND). In other words, the current flow through the light-emitting element 23 is determined by the sum of the internal resistance r of the same element 23 and the resistance of the first resistor R1. This current flow is larger than that determined by the sum of the internal resistance r of the same element 23 and the resistances of the first and second resistors R1 and R2. In other words, the brightness (second brightness) of the light-emitting element 23 when the first and second signals are both ON (high) is higher than that (first brightness) when the first signal is ON (high) and the second signal is OFF (low).

Further, when the first and second signals are both OFF (low), the output of the AND circuit A is “low.” At this time, the gate terminals (G) of the first, second, and third transistors Q1, Q2, and Q3 are “low.” As a result, none of these transistors conduct between the drain terminal (D) and source terminal (S). Therefore, the brightness of the light-emitting element 23 is “0” (third brightness).

Further, when the first signal is OFF (low) and the second signal is ON (high), the output of the AND circuit A is “low.” The gate terminals (G) of the first and second transistors Q1 and Q2 are supplied with a “low” signal. As a result, these transistors do not conduct between the drain terminal (D) and source terminal (S). However, the gate terminal (G) of the third transistor Q3 is “high.” As a result, this transistor conducts between the drain terminal (D) and source terminal (S). At this time, current flows through the first resistor R1 first, then the light-emitting element 23, then the drain and source of the third transistor Q3, and into the common terminal (GND). In other words, the current flow through the light-emitting element 23 is determined by the sum of the internal resistance r of the same element 23 and the resistance of the first resistor R1. In other words, the brightness of the light-emitting element 23 at this time is the same as the first brightness.

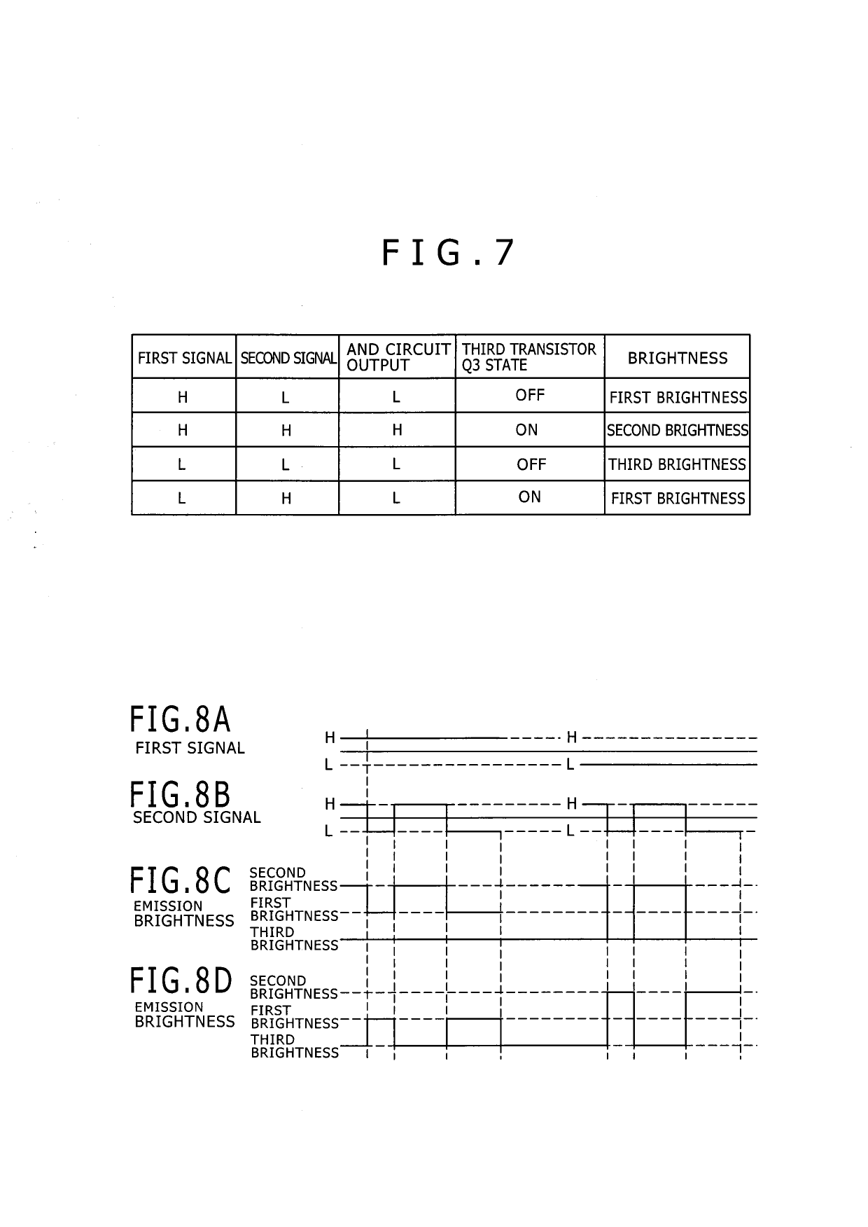

That is, in the circuit illustrated in FIG. 6, the emission brightness of the light-emitting element 23 changes according to the states of the first and second signals as illustrated in FIG. 7. In the example illustrated in FIG. 6, when the first signal is “high” and the second signal is “low,” the light-emitting element 23 emits light at the first brightness. Further, when the first and second signals are both “high,” the light-emitting element 23 emits light at the second brightness.

Still further, in the circuit illustrated in FIG. 6, when the first signal is “low” and the second signal is “high,” the light-emitting element 23 emits light at the first brightness. Still further, when the first and second signals are both “low,” the light-emitting element 23 does not emit light. Alternatively, in the circuit illustrated in FIG. 6, a third resistor may be provided between the point X and the drain terminal (D) of the third transistor Q3. This provides a fourth brightness different from any of the first, second or third brightness when the first signal is “low” and the second signal is “high.” As a result, when the light-emitting element 23 emits light at the third brightness according to the first signal, the third transistor Q3 serving as a second brightness control block controls the same element 23 to emit light at the fourth brightness different from any of the first, second or third brightness.

The signal output apparatus 2 according to one form of the present embodiment includes the above components and operates as described below. In the description given below, we assume that the first signal represents the current passage condition (ON/OFF state of the power), and that the second signal debug information. We assume that debug information is, for example, N-bit long data (where N>1), and that the second signal outputs debug information n bits at a time every second. This ‘n’ may be, for example, a value that does not permit human eyes to visually identify flashing resulting from the change in bit value.

In this example, when the signal output apparatus 2 is powered ON, the first signal turns ON (goes high). Further, the same device 2 outputs debug information when instructed to do so by the user or when a predetermined time comes as when the power is turned ON.

That is, the functional section 21 of the signal output apparatus 2 outputs a second signal based on (N-bit) debug information to be output. Alternatively, the same section 21 may add a widely known (L-bit) error correction or detection code to the debug information, thus generating (N+L)-bit information and outputting a second signal based on this information.

Assuming, as an example, that part of the information to be output is “101100,” and that the functional section 21 exercises control in such a manner that the second signal is “high” when the bit value is “1” and that the second signal is “low” when the bit value is “0,” the second signal for the above part of the information is “high, low, high, high, low, and low.”

Therefore, if the emission control circuit 22 is as illustrated in FIG. 2, and if, as illustrated in FIG. 8, the second signal is output n bits at a time every second while the first signal is “high,” the second signal changes successively in level from “high” to “low” to “high” to “high” to “low” to “low” and so on every 1/nth of a second. For this reason, the light-emitting element 23 emits light at the second brightness when the second signal is “high.” Further, the same element 23 emits light at the first brightness which is slightly lower than the second brightness when the second signal is “low” (FIG. 8C). It should be noted that the light-emitting element 23 is lit at this first brightness while the second signal is output.

Further, if the emission control circuit 22 is as illustrated in FIG. 4A or 4B, the brightness of the light-emitting element 23 is “0” (third brightness) when the second signal is “high.” Still further, the light-emitting element 23 emits light at the first brightness when the second signal is “low” (FIG. 8D). It should be noted that the light-emitting element 23 is lit at the first brightness while the second signal is not output (is “low”).

It should be noted that the case in which the first signal is “low” is also shown for reasons of explanation in FIG. 8. Practically, however, the second signal may be output while the first signal is either “high” or “low.”

A description will be given next of the sections of the signal reception apparatus 3. The microcomputer 31 of the signal reception apparatus 3 stores a predetermined program and operates according to this program. This microcomputer 31 receives a signal representing the intensity of light received by the light-receiving element 33 and converts this signal into a digital value. Then, the microcomputer 31 reproduces the value of the first or second signal on the side of the signal output apparatus 2 from the digital value obtained from the conversion. This process will be described later.

Further, the microcomputer 31 may control the light-emitting element 32 to flash in a predetermined pattern. This operation will be also described later.

The light-emitting element 32 is, for example, a light-emitting diode adapted to light up or go out according to the instruction supplied from the microcomputer 31. The light-receiving element 33 is, for example, an optical sensor such as photodiode adapted to detect the intensity (brightness) of received light and output a signal representing the brightness.

The information output section 34 is an interface such as USB adapted to output information to external equipment according to the instruction supplied from the microcomputer 31.

A description will be given here of the operation of the microcomputer 31. We assume here that the light-receiving element 33 of the signal reception apparatus 3 receives light emitted by the light-emitting element 23 of the signal output apparatus 2. The microcomputer 31 incorporates an ADC (Analog to Digital Converter) adapted to convert the signal output from the light-receiving element 33 into a digital value at a predetermined timing, successively storing the converted digital values.

The microcomputer 31 finds the minimum and maximum of the stored digital values. Further, the microcomputer 31 determines a threshold between the calculated minimum and maximum and estimates the states of the first and second signals based on whether the output value exceeds this threshold. Then, the microcomputer 31 outputs the estimation result via the information output section 34.

For example, if light whose brightness changes as illustrated in FIG. 8C is received by the light-receiving element 33, and if the signal output from the light-receiving element 33 every 1/nth of a second is converted into a digital value and stored, the stored digital value changes, for example, from 233 to 115 to 240 to 244 to 117 to 122 and so on due to varying light reception conditions. For this reason, the microcomputer 31 obtains “115” as a minimum and “244” as a maximum and determines “179.5,” i.e., the value obtained by dividing the sum of the minimum and maximum by two as a threshold.

The microcomputer 31 outputs information to the effect that the signal conveyed from the signal output apparatus 2 is “high” when a value beyond the determined threshold is output. The microcomputer 31 outputs information to the effect that the signal conveyed from the signal output apparatus 2 is “low” when a value below the determined threshold is output. Therefore, the microcomputer 31 obtains information “high, low, high, high, low, and low” from the above digital value as the estimation result of the signal conveyed from the signal output apparatus 2. The microcomputer 31 outputs the result of the estimation made as described above in an ‘as-is’ manner as decoded information.

On the other hand, if an error correction or detection code has been added to information to be transmitted by the signal output apparatus 2, the microcomputer 31 may decode the information by performing error correction (if an error correction code has been added) or error detection (if an error detection code has been added) on the estimation result rather than outputting the estimation result in an ‘as-is’ manner. Then, if error correction is successful, or if no error has been detected, the microcomputer 31 outputs the decoded information to external equipment. For example, the microcomputer 31 displays the decoding result on a display serving as external equipment. This allows second information of the signal output apparatus 2 to be decoded by the signal reception apparatus 3 and displayed. The user proceeds with debugging or other task using this decoded information.

On the other hand, a description will be given below of the signal reception apparatus 3 if the light-emitting element 23 emits light at a different brightness for each of four possible states which the combination of the first and second signals can take as when the third resistor is provided between the drain terminal (D) of the first transistor Q1 (shown as the point X in FIG. 6) and the drain terminal (D) of the third transistor Q3 in the circuit shown in FIG. 6.

In this case, although the signal reception apparatus 3 is basically configured in the same manner as those described earlier, the operation of the microcomputer 31 is slightly different. That is, the microcomputer 31 converts the signal output from the light-receiving element 33 into digital values at every predetermined timing, successively storing the converted digital values.

The microcomputer 31 finds a minimum Vmin and maximum Vmax of the stored digital values. Then, the microcomputer 31 sets three thresholds between the Vmin and Vmax. More specifically, the microcomputer 31 finds Va=(Vmax−Vmin)/3 and Vb=2×(Vmax−Vmin)/3 and determines a first threshold Th1 as Th1=(Vmax+Vb)/2. Further, the microcomputer 31 determines a second threshold Th2 as Th2=(Va+Vb)/2. Still further, the microcomputer 31 determines a third threshold Th3 as Th3=(Va+Vmin)/2.

Then, the microcomputer 31 estimates that both the first and second signals are “high” if a value beyond the first threshold is output. The microcomputer 31 estimates that the first signal is “high” and the second signal is “low” if a value beyond the second threshold but not the first threshold is output. The microcomputer 31 estimates that the first signal is “low” and the second signal is “high” if a value beyond the third threshold but not the second threshold is output. The microcomputer 31 estimates that both the first and second signals are “low” if a value below the third threshold is output.

Then, the microcomputer 31 outputs the estimation result via the information output section 34. It should be noted that if the signal output apparatus 2 contains an error correction or detection code in each of the first and second signals to be transmitted, an error correction or detection code is contained in the estimation result information as described earlier. In this case, the microcomputer 31 decodes first and second pieces of information using the code in the same manner as described earlier.

In the above examples, on the other hand, the timing at which the signal output apparatus 2 is to output, for example, debug information is set separately, or an instruction regarding the timing is received by a separate component different from the component of the circuit in FIG. 2. However, if the light-emitting element 23 can also serve as a light-receiving element such as an LED, the same element 23 may be used as a light-receiving element to receive the instruction in the form of an optically modulated signal, thus transmitting target information according to the instruction.

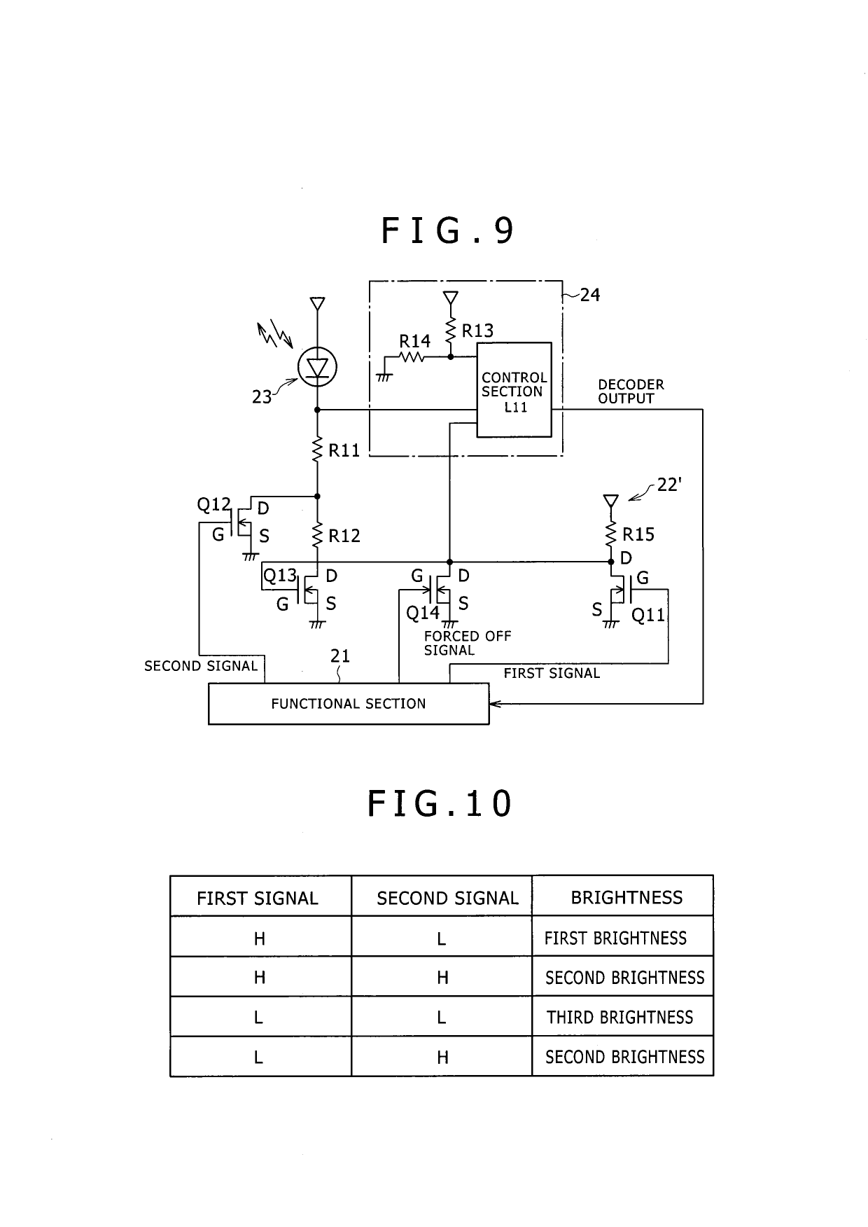

A description will be given below of such a form. The signal output apparatus 2 in this form includes the functional section 21, an emission control circuit 22′, the light-emitting element 23 and a decoder 24 as illustrated in FIG. 9. It should be noted that like components to those described earlier are denoted by the same reference symbols.

In this example, the emission control circuit 22′ and decoder 24 include first to fifth resistors R11, R12, R13, R14, and R15, first to fourth transistors Q11, Q12, Q13, and Q14 and a control circuit L11. Here, the transistors Q11, Q12, Q13, and Q14 are all n-type FETs.

The anode of the light-emitting element 23 is supplied with the source voltage. Further, the same element 23 has its cathode connected to the drain terminal (D) of the third transistor Q13 via the first and second resistors 11 and 12. The second transistor Q12 has its drain terminal (D) connected to the point to which the first and second resistors 11 and 12 are connected. The gate terminal (G) of the second transistor Q12 is supplied with the second signal.

On the other hand, the control circuit L11 is supplied with the potential obtained by dividing the source voltage with the third and fourth resistors R13 and R14. Further, the same circuit L11 is connected to the cathode of the light-emitting element 23. Still further, the same circuit L11 is connected to the drain terminal (D) of the fourth transistor Q14. The fourth transistor Q14 has its drain terminal (D) connected to the gate terminal (G) of the third transistor Q13 and the drain terminal (D) of the first transistor Q11. The gate terminal (G) of the fourth transistor Q14 is supplied with a forced OFF signal that goes “high” when the light-emitting element 23 is turned OFF.

The drain terminal (D) of the first transistor Q11 is supplied with the source voltage via the fifth resistor R15. Further, the gate terminal (G) of the same transistor Q11 is supplied with the first signal. The first to fourth transistors Q11 to Q14 have their source terminals (S) connected to the common terminal (GND).

Then, the circuit shown in this example operates in the following manner. A description will be given first of the case in which the forced OFF signal is “low” (the fourth transistor Q14 is OFF). At this time, when the first signal is ON (high) and the second signal is OFF (low), the first transistor Q11 conducts between the drain terminal (D) and source terminal (S). On the other hand, the potential of the gate terminal (G) of the third transistor Q13 is pulled down to the potential (low) of the common terminal (GND). As a result, the third transistor Q13 does not conduct between the drain terminal (D) and source terminal (S). On the other hand, the second transistor Q12 does not conduct between the drain terminal (D) and source terminal (S), either. Therefore, the brightness of the light-emitting element 23 is “0” (OFF). In this example, the “0” brightness is the first brightness.

On the other hand, when the first and second signals are both ON (high), the first and second transistors Q11 and Q12 conduct between the drain terminal (D) and source terminal (S). In this case, current flows through the light-emitting element 23, then the first resistor R11, then the drain and source of the second transistor Q12, and into the common terminal (GND). In other words, the current flow through the light-emitting element 23 is determined by the sum of the internal resistance r of the same element 23 and the resistance of the first resistor R11.

Further, if the first signal turns OFF (goes low), the first transistor Q11 is brought out of conduction between the drain terminal (D) and source terminal (S), thus supplying a “high” signal to the gate terminal (G) of the third transistor Q13. As a result, the third transistor Q13 conducts between the drain terminal (D) and source terminal (S). If the second signal is also OFF (low) at this time, the second transistor Q12 does not conduct between the drain terminal (D) and source terminal (S). Therefore, current flows through the light-emitting element 23, then the first and second resistors R11 and R12, then the drain and source of the third transistor Q13, and into the common terminal (GND). In other words, the current flow through the light-emitting element 23 is determined by the sum of the internal resistance r of the same element 23 and the resistances of the first and second resistors R11 and R12. This current flow is smaller than that determined by the sum of the internal resistance r of the same element 23 and the resistance of the first resistor R11. In other words, the brightness (third brightness) of the light-emitting element 23 when the first and third signals are both OFF (low) is lower than that (second brightness) when the first and second signals are both ON (high).

On the other hand, when the first signal is OFF (low) and the second signal is ON (high), the second transistor Q12 conducts between the drain terminal (D) and source terminal (S). Current flows through the light-emitting element 23, then the first resistor R11, then the drain terminal and source terminal of the second transistor Q12, and into the common terminal (GND). In other words, the current flow through the light-emitting element 23 is determined by the sum of the internal resistance r of the same element 23 and the resistance of the first resistor R11. In other words, the brightness of the light-emitting element 23 at this time is the same as the second brightness.

That is, in the circuit illustrated in FIG. 9, the emission brightness of the light-emitting element 23 changes according to the states of the first and second signals as illustrated in FIG. 10. In other words, when the first signal is “high” and the second signal is “low,” the light-emitting element 23 does not emit light (the brightness with no light emitted is the first brightness in this example). Further, when the first and second signals are both “high,” the light-emitting element 23 emits light at the second brightness.

Still further, when the first and second signals are both “low,” the light-emitting element 23 emits light at the third brightness. Still further, when the first signal is “low” and the second signal is “high,” the light-emitting element 23 emits light at the second brightness.

It should be noted that when the forced OFF signal is “high,” the fourth transistor Q14 conducts between the drain terminal (D) and source terminal (S). As a result, the gate terminal (G) of the third transistor Q13 is pulled down to the potential (low level) of the common terminal (GND), thus bringing the same transistor Q13 out of conduction. In other words, the same condition occurs as when the first signal is “high.” Therefore, if the second signal is low (OFF), the light-emitting element 23 continues to be unlit while the forced OFF signal remains “high” irrespective of the state of the first signal.

The control circuit L11 compares the potential of the cathode of the light-emitting element 23 and the potential (reference potential) obtained by dividing the source voltage with the third and fourth resistors R13 and R14 when the potential of the drain terminal (D) of the fourth transistor Q14 is equal to that of the common terminal (GND) (when the potential of the gate terminal (G) of the third transistor Q13 is pulled down to the potential (low level) of the common terminal (GND), as a result of which the same transistor Q13 does not conduct between the drain terminal (D) and source terminal (S)), thus outputting the comparison result.

That is, if an LED is used as the light-emitting element 23, irradiating light onto the LED while it is unlit changes the potential between the anode and cathode thereof from that when no light falls on the LED. For this reason, the reference potential is set between the potential with light irradiated onto the light-emitting element 23 and that with no light irradiated thereonto (the resistances of the third and fourth resistors R13 and R14 are adjusted as appropriate). Then, the control circuit L11 compares the cathode potential and reference potential, thus detecting whether light is irradiated onto the light-emitting element 23.

In an example of the present embodiment, if the flashing of light irradiated onto the light-emitting element 23 is an optical signal whose level changes in a predetermined pattern, the control circuit L11 may detect the presence of flashing in the pattern and output an instruction to the functional section 21 that the output of the second signal should be initiated, as a result of which the same section 21 initiates the output of the second signal according to the instruction.

More specifically, the control circuit L11 treats the period of time during which the potential of the drain terminal (D) of the fourth transistor Q14 is pulled down to the potential (low) of the common terminal (GND) as the period of time during which the light-emitting element 23 is unlit (OFF). The same circuit L11 compares the cathode potential of the light-emitting element 23 and the reference potential during this period of time, outputting the comparison result in the form of a high or low level signal. The control circuit L11 examines whether the signal level changes in the predetermined pattern (e.g., pattern in which the signal level changes from “high” to “low” to “high” to “low”). This can be accomplished, for example, by simply extracting the signal level at a predetermined timing and examining whether the change in the extracted signal level matches the predetermined pattern.

When the signal level change matches the predetermined pattern, the control circuit L11 outputs an instruction to the functional section 21 that the output of the second signal should be initiated, as a result of which the same section 21 initiates the output of the second signal according to the instruction. This allows the light-emitting element 23 to serve as a light-receiving element adapted to receive an optical signal from external equipment when the same element 23 turns OFF according to the first signal and when control is not exercised according to the second signal (when the second transistor Q12 is OFF).

Further, if the light-emitting element 23 receives an optical signal, the forced OFF signal may be set to “high” level. This setting may be accomplished, for example, by using a switch. Alternatively, the functional section 21, for example, may control the forced OFF signal to go to “high” level at a predetermined timing such as within a predetermined amount of time after power-on.

It should be noted that the optical signal having a predetermined pattern may be irradiated by the signal reception apparatus 3. The microcomputer 31 of the signal reception apparatus 3 here causes the light-emitting element 32 to flash in the predetermined pattern when supplied with an instruction from the user. For example, if the signal level changes from “high” to “low” to “high” to “low” every ΔT in the pattern, the microcomputer 31 controls the same element 32 to light up, then go out, then light up and then go out every ΔT.

In this case, the control circuit L11 of the signal output apparatus 2 compares the cathode potential of the light-emitting element 23 and the reference potential within the period of time in which the potential of the drain terminal (D) of the fourth transistor Q14 is pulled down to the potential (low) of the common terminal (GND) (during which the light-emitting element 23 is OFF). Then, the same circuit L11 outputs the comparison result in the form of a signal which goes to “high” level when the cathode potential is higher than the reference potential and “low” level when the cathode potential is lower than the reference potential. The level of this signal is extracted at a predetermined timing, namely, every ΔT. Then, the control circuit L11 examines whether the change in the extracted signal level matches the predetermined pattern in which the signal level changes from “high” to “low” to “high” to “low.” When the signal level change matches the predetermined pattern, the control circuit L11 causes the functional section 21 to output the second signal. From here onward, the light-emitting element 23 flashes based on the first and second signals, thus allowing a signal to be output by means of the flashing of the same element 23.

As described above, in the present embodiment, a light-emitting element such as LED is controlled to flash using a certain signal (first signal). Further, the brightness of the same element is controlled using a signal to be output (second signal), thus superimposing the second signal output on the first signal output. This minimizes the increase in cost, not providing the light-emitting element for the second signal, thus making it possible to output the second signal such as debug information without the user readily noticing the existence of the second signal thanks to superimposition thereof on the first signal.

It should be understood by those skilled in the art that various modifications, combinations, sub-combinations and alterations may occur depending on design requirements and other factors insofar as they are within the scope of the appended claims or the equivalents thereof.

What is claimed is:

1. A signal output apparatus, comprising:
a light-emitting element;
first brightness control circuitry configured to be supplied with a first signal and control a brightness of the light-emitting element according to the first signal so as to illuminate the light-emitting element at a first brightness when the first signal is ON; and
second brightness control circuitry configured to be supplied with a second signal including at least first and second states and control the light-emitting element to be illuminated at a second brightness different from the first brightness if the second signal assumes the first state when the light-emitting element is illuminated by the first control circuitry at the first brightness according to the first signal.

2. The signal output apparatus of claim 1, wherein
the first brightness control circuitry controls the emission state of the light-emitting element so that the light-emitting element is illuminated at a third brightness different from the first or second brightness when the first signal is OFF.

3. The signal output apparatus of claim 1, further comprising:
an emission control circuit configured to be supplied with information to be output and code the information to be output into the second signal by adding an error correction or detection code to the second signal.

4. The signal output apparatus of claim 1, wherein
the light-emitting element is configured to receive an optical signal from external equipment when the first signal is OFF, and when the second brightness control circuitry does not exercise control according to the second signal.

5. The signal output apparatus of claim 1, wherein
the light-emitting element is configured to not be illuminated when receiving an optical signal, and
the second brightness control circuitry controls the brightness of the light-emitting element according to the second signal when a predetermined signal is received by the light-emitting element.

6. The signal output apparatus of claim 1, wherein
the first brightness control circuitry including:
a first resistor connected between a power source and the light-emitting element;
a second resistor connected between the light-emitting element and a first drain terminal of a first transistor; and
the first transistor having a first source terminal connected to ground, a first gate terminal connected to a first signal line providing the first signal, and the first drain terminal connected to the second resistor.

7. The signal output apparatus of claim 6, wherein
the second brightness control circuitry includes a second transistor having a second source terminal connected to ground, a second gate terminal connected to a second signal line providing the second signal, and a second drain terminal connected to a point between the light emitting element and the second resistor.

8. A signal transmitting and receiving system, comprising:
a signal output apparatus; and
a signal reception apparatus;
the signal output apparatus including:
a light-emitting element;
first brightness control circuitry configured to be supplied with a first signal and control a brightness of the light-emitting element according to the first signal so as to illuminate the light-emitting element at a first brightness when the first signal is ON; and
a second brightness control circuit configured to be supplied with a second signal including at least first and second states and control the light-emitting element to be illuminated at a second brightness different from the first brightness if the second signal assumes the first state when the light-emitting element is illuminated by the first control circuitry at the first brightness according to the first signal,
the signal reception apparatus including:
a detector configured to detect the brightness of the light-emitting element of the signal output apparatus; and
a decoder configured to decode the second signal that has been output based on the detected brightness.
